(19) United States
(12) Patent Application Publication
(10) Pub. No.: US 2007/0099014 A1
(43) Pub. Date: May 3, 2007

(54) Method for applying a low coefficient of friction coating

(75) Inventors: Richard McCullough, Westbury, NY (US); Richard Schmid, Westbury, NY (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: Sulzer Metco (US), Inc.

(21) Appl. No.: 11/265,212

(22) Filed: Nov. 3, 2005

(51) Int. Cl. B05D 1/12; B32B 15/04

(52) U.S. Cl. 428/469; 427/180; 427/446

(57) ABSTRACT

The present invention provides a composite coating and a method of preparing a composite coating resistant to galling and fretting. The coating is applied to a substrate and includes a mixture of hard carbide particles in an alloy matrix or oxides and solid lubricant particles captured in a binder. The coating is produced by using a thermal spray process to apply a powder containing both the hard face or oxide phases as well as the self lubricating phases. Thus, the applied coating of the present invention combines the benefits achieved with previous thermal spray coatings in terms of wear, abrasion, heat and corrosion with those afforded by solid lubricants. In addition, the coating of the present invention provides consistently distributed surface porosity to retain liquid lubricant on the coating surface.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

1. Field of the Invention

The present invention relates to a composite thermal spray coating and method of making the coating, and more particularly to a coating that is produced by using a thermal spray process to apply a powder containing both a hard phase material, such as a carbide or oxide, and a self lubricating phase material, such as graphite.

2. Description of the Related Art

In various machines and machinery with parts that require lubrication, there are occasions where the lubricated parts are starved of lubrication, or high exertion forces render the lubrication ineffective. For machines like pumps, motors, and turbines, there are two basic types of lubrication systems. One type of lubricant is pressure based, typically found in combustion engines and turbines, wherein a lubricant is forced into the bearing or seal under pressure. The other type of lubricant is hydrodynamic, typically used on small motors and pumps, wherein the lubrication is drawn into the seal or bearing as a result of the rotation of the mating surface. In both lubrication systems, the principle is to establish a layer of lubricant under pressure between mating parts. Insufficient pressure, either as a result of low sliding speeds (hydrodynamic) or low supply pressure (pressure based) results in increased friction and wear as expressed in the Stribeck Curve, the characteristic curve of the coefficient of friction versus sliding speed.

During startup, the seals, bearing surfaces, and rings lack liquid lubrication until the lubrication system either comes up to pressure or the rotating parts achieve sufficient rotation velocity to draw the lubricant into the gap between the parts. This condition is worsened the longer the machine is idle between startups as the residual lubrication on the surfaces drains. The loss of lubrication while components are stationary is especially a problem with hydrodynamic seals, and the lubrication may be nothing more than water, as is the case with boiler pumps. Thus, for some machines, it is not only the number of hours in operation but the number of startup cycles that determines component life. One solution for pressure based lubricating systems is to pre-start the lubrication system prior to machine startup; but this has limited advantage as some seals and bearings will still have surfaces that are devoid of lubricant until the rotational parts of the machine reach operating speed (hydrodynamic component). For hydrodynamic lubrication there is no easy or viable solution in terms of pre-starting the lubrication; the parts simply must have a sufficient sliding speed to exceed boundary lubrication conditions.

Some pumps and motors are exposed to high exertion forces due to their nature of changing power output rapidly. These forces, when translated to seals and bearings, can momentarily overcome the lubrication pressure separating the mating parts, causing the surfaces to make contact. As a result, the lifetimes of these components are shortened and friction and additional heat are introduced into the machine.

Developments in thermal spray technology over the years have introduced a number of coatings that can extend the life of bearing surfaces. The most simple and basic is a wear or erosion resistant coating consisting of a hard metal, such as molybdenum (Mo). This coating does not solve the root lubrication problem but does extend the life of the lubricated surfaces. For more extreme applications, coatings that not only resist wear but afford some protection from corrosion, heat, and oxidation have been created, such as tungsten carbide and chrome carbide. With the use of these coatings, the underlying problem—lack of lubrication—remains, but the components survive longer in their intended operating environment. It has been previously known to add a solid lubricant to the coating matrix in that a graphite solid lubricant clad in nickel was introduced as part of a coating. This addition substantially improved the performance of the coating in use. The addition of a solid lubricant provided reduced wear rates and lower friction at lower speeds but there is room for improvement. There remains a need in the art for a coating that provides not only lubrication in addition to the protection of traditional coatings at low operating speeds, but also a method of improving the performance of the lubrication itself at those lower speeds.

As an example of the state of conventional coating systems, thermal shock testing was conducted on a boiler pump wear ring made with a tungsten carbide and cobalt chrome matrix coating applied by conventional methods (e.g., without micro-pore inclusions and other techniques disclosed in the present invention). Thermal shock is common when components are heated and subsequently purged or otherwise quickly cooled for installation. When clearances are especially tight, components may require shrink fitting onto other components. This involves using a heating mechanism, such as an oxygen-acetylene flame to expand and fit the component. Once the components are fitted they are often shrunk using an accelerant such as immersing them in cold water or using liquid carbon dioxide, nitrogen or argon. In the tested wear ring sample, cracking was clearly evident at the bottom edge of the component. The cause of the cracks is from two properties inherent to the coating. The first property is the pre-existing tensile stress when the coating was produced. Coupled with the second property of the coating to be brittle results in the coating cracking when subjected to thermal shock. There remains a need for lubricated coatings that exhibit good thermal shock resistance properties.

In addition to the protection the coatings offer, the porosity inherent in thermal spray coatings has been observed to trap some liquid lubrication. This trapped lubrication results in reduced friction and heat when there is no lubricating layer. Typically the creation of pores in thermal spray coatings is haphazard and unpredictable, and is normally considered a flaw in the coating process. Thus, there remains a need in the art for a coating and application method that can include consistent porosity to retain liquid lubricant while still providing maximum protective functionality.

### SUMMARY

To address the aforementioned deficiencies in conventional systems, the present invention provides a composite coating and method for forming and applying a composite coating that is resistant to galling, fretting, and sliding wear. The coating is applied to a substrate and includes a mixture of hard carbide particles with an aggregate size range of less than about 2 μm in an alloy matrix or oxides with an aggregate size range of less than about 0.5 μm and solid lubricant particles captured in a binder. The coating is produced by using a thermal spray process to apply a powder with a hard face (or oxide) phase and a self lubricating phase such that the resulting coating exhibits neutral or compressive residual stress. Thus, the applied coating of the present invention combines the benefits achieved with previous thermal spray coatings in terms of wear, abrasion, heat and corrosion with those afforded by solid lubricants as an optimal coating using the latest techniques in thermal spray to produce the feedstock and apply the coating. In addition, the coating of the present invention provides consistently distributed surface porosity to retain liquid lubricant on the coating surface.

According to one embodiment of the present invention, a method of forming a coating is provided. The coating has a low coefficient of friction that is wear resistant, corrosion resistant, and heat resistant. The method includes the steps of providing particles that include a hard face material, providing particles that include a solid lubricant material, applying both of the particle types to a substrate to form the coating, wherein the coating includes a blend of the hard face material and the solid lubricant material. The hard face material particles may be made of one or more of chromium carbide, tungsten carbide, titanium carbide, molybdenum carbide, and vanadium carbide. The solid lubricant material particles may be one or more of graphite, boron nitride, silicone, polyester, and PTFE.

According to another embodiment, the fine particles of carbide hard phase material that are less than about 2 μm are agglomerated into larger particles using a binder material before they are combined in order to better facilitate passing through the thermal spray process. The binder material is made of one or more of cobalt, nickel and iron alloyed with one or more of chrome, molybdenum, vanadium and copper.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE DRAWINGS

The accompanying drawings are included to provide further understanding of the invention and are incorporated in and constitute a part of this specification. The accompanying drawings illustrate embodiments of the invention and together with the description serve to explain the principles of the invention. In the figures:

FIG. 1 provides a flow chart of a coating application process in accordance with an embodiment of the present invention;

FIG. 2 shows a cross section of an agglomerated hard phase particle;

FIG. 3 shows a cross section of a solid lubricant particle;

FIG. 4 is a cross-sectional view illustrating the application of a coating system in accordance with an embodiment of the present invention;

FIG. 5 is a cross-sectional view illustrating the applied coating system in accordance with an embodiment of the present invention;

FIG. 6 is a magnified view of a microstructure of a coating applied in accordance with an embodiment of the present invention;

FIG. 7 is a magnified view of a surface of a coating applied in accordance with an embodiment of the present invention; and

FIG. 8 shows a component coated with a coating applied in accordance with an embodiment of the present invention.

### DETAILED DESCRIPTION OF THE INVENTION

Reference will now be made in detail to the preferred embodiments of the present invention, examples of which are illustrated in the accompanying drawings.

The invention as defined herein uses two separate thermal spray materials, blended together to achieve a thermal spray coating that combines the benefits achieved with previous thermal spray coatings in terms of wear, abrasion, heat and corrosion with those afforded by solid lubricants. When applied using a thermal spray process in accordance with the invention, the resulting coatings exhibit the properties necessary to provide superior galling, fretting and sliding wear resistance in applications where components requiring lubrication are operated in conditions where the components are at least temporarily void of lubrication or where the lubrication pressure is temporarily compromised. As used herein, thermal spray processes refer to, but are not limited to, high velocity oxygen fuel (HVOF), high velocity liquid fuel (HVLF), high velocity air fuel (HVAF), plasma, cold spray, detonation processes, and similar processes.

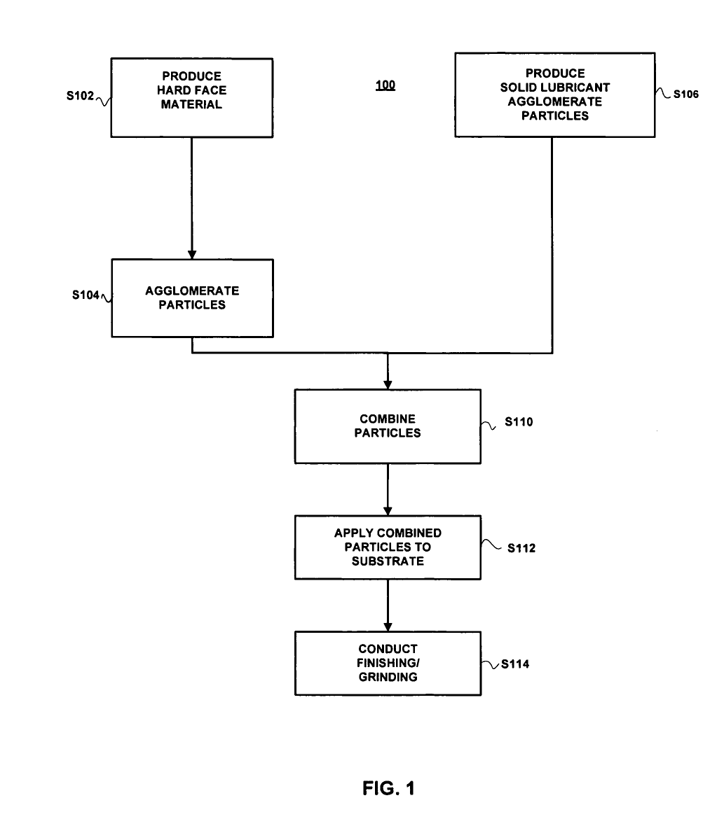

FIG. 1 provides a flow chart of the process for preparing a coating in accordance with an embodiment of the present invention. As shown in FIG. 1, the method 100 for applying the coating requires the separate production of two types of particulate material. The process begins in step S102 where hard face material particles are produced for thermal spray application.

The hard face materials produced in step S102 provide the necessary wear resistance as well as resistance to heat, corrosion, and oxidation. Typical carbides include tungsten carbide, chromium carbide, titanium carbide and vanadium carbide, all of which are commonly used thermal spray materials. Carbides provide excellent erosion, corrosion, and heat resistance. However, carbides do not perform well in environments that are starved of lubrication as they possess poor coefficients of friction. In addition, materials such as agglomerated nano titanium oxide (TiO₂), chrome oxide (Cr₂O₃), aluminum oxide (Al₂O₃), or mixtures thereof also offer similar benefits as a hard face material in that the nano particles have higher ductility and are considerably less brittle than coatings produced using larger particles. For example, chromium carbide is a good material choice, as the corrosion and oxidation resistance is the highest and the use of this material creates a coating that has a high resistance to thermal shock gradients when applied using the appropriate thermal spray process.

The particle size of the carbides formed as a raw powder in step S102 needs to be small, for example about than 2 microns (μm) or smaller, to produce a coating with good ductility. One method to prepare the carbide particles is to use an attrition mill to grind the particles and then use an inert gas atomizing process to produce particles less than 0.5 μm. An alternate method after grinding in an attrition mill is to spray dry and sinter which will produce larger particles of about 2 μm. The process then moves to step S104. In step S104, the small particle raw powder is agglomerated into larger particles using a binder material. The agglomeration may be accomplished using an inert gas atomizer or by a spray drying and sintering process.

The binder materials used in step S104 are selected based on a number of factors to additionally benefit the resulting coating. First, the base material of the binder may be selected from the group of iron (Fe), cobalt (Co), or nickel (Ni). For corrosion resistance, nickel exhibits the best properties, followed by cobalt, and then iron. The alloying of chromium (Cr) (for example, less than 30% by weight) to the base material adds corrosion resistance. The alloying of vanadium (V) (for example, less than 10% by weight) to the base material aids in forming vanadium carbide over the formation of chrome carbide during the thermal spraying process in the presence of free carbon atoms residual from the process of forming carbides, leaving the chromium in the alloy matrix free for added corrosion resistance. The alloying of molybdenum (Mo) (for example, less than 10% by weight) adds wear and corrosion resistance. The alloying of copper (Cu) in low concentrations (less than 5% by weight) adds corrosion resistance.

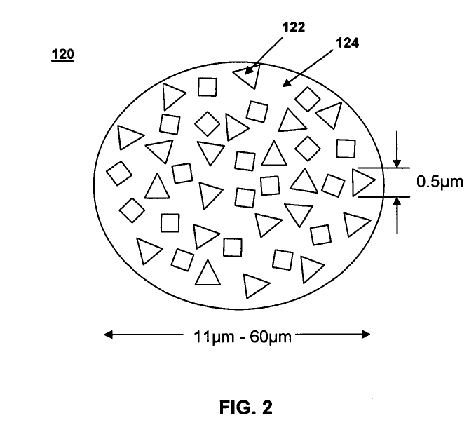

Preparation of the agglomerated hard face particles in step S104 is preferably performed using an inert gas oven to melt the binder, followed by introduction of the carbide particles and then inert gas atomizing to produce acceptable particle sizing for thermal spray application. This results in carbide particles about 0.5 μm or smaller in the alloy matrix. The final agglomerated particles are preferred to be in the size range of about 11 μm to about 60 μm. FIG. 2 shows a cross section of an agglomerated hard phase particle 120 with carbide particles 0.5 μm or smaller 122 embedded in the alloy binder 124 to form a particle that is roughly between 11 μm and 60 μm.

As described above, as an alternate form of the hard face material, nano titania (TiO₂), nano chromia (Cr₂O₃), and/or nano alumina (Al₂O₃) may be used. These oxides are formed first as nano crystals less than about 0.1 μm in step S102 and then agglomerated in a spray drying process followed by plasma reprocessing to form congealed particles of suitable size for thermal spray application in step S104. Variations in processing will result in variations in the properties of the resulting coating that can be tailored to alter properties such as wear resistance, hardness, ductility, resistance to cracking, etc. The processing of the material uses a binder in the initial steps that does not remain in the final product. The use of additives similar to those used with the carbides (such as chromium or vanadium to aid in corrosion, heat, and wear resistance) is not required for the aforementioned nano oxides. Furthermore, the use of metal alloys as a binder will not add additional corrosion or wear protection, and are not required.

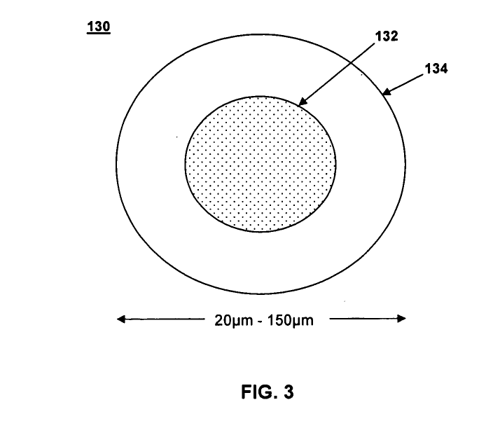

In step S106, the second thermal spray material is produced. This material is a solid lubricant to provide a low coefficient of friction for purposes of lubrication of the component. Typical solid lubricants that can be thermal sprayed include graphite, boron nitride, silicone, polyester, and polytetrafluoroethylene (PTFE). Because these materials possess release agent characteristics, their spray-ability can be poor and in the case of graphite could result in the formation of undesirable carbides with the metal alloy binder of the hard phase material. To improve spray-ability and prevent reactive formations with the hard phase material, they can be clad in nickel, cobalt, copper, molybdenum or gold or alloys thereof. Alternatively, the solid lubricants can be spray-dried with a suitable binder such as, for example, polyvinyl alcohol (PVA) or carboxymethylcellulose (CMC). The preferred use of the metallic clad materials have other key benefits in the resulting coating as well when applied using a thermal spray process as described previously in the preparation of the hard phase material. The preferred material choice is graphite clad in nickel. The use of cladding is required for use of some materials, such as polyester, that cannot otherwise withstand some thermal spray processes. Materials like polyester could vaporize or decompose in the plume of the plasma gun if the plasma spray process is used to apply the coating or could oxidize in either the cold spray or HVOF processes. The resulting agglomerated solid lubricant particles should be larger than those for the agglomerated hard phase particles and preferably in the range of about 20 μm to 150 μm. FIG. 3 shows a cross section of a particle 130 with solid lubricant 132 clad in a metallic shell 134 and with a particle size in the range of about 20 μm to about 150 μm. The larger particle size range for the solid lubricant is necessary to ensure that the entrained particles are of sufficient size to facilitate pull out of a sufficient number of particles at the surface during finishing. It should be understood that steps S102/S104 and step S106 may be carried out simultaneously or in succession.

The process then moves to step S110, where the two above-described thermal spray materials are combined. The particles can be pre-blended prior to feeding into the thermal spray process or they can be fed into the thermal spray process as two separate materials. Feeding the materials separately provides the advantage of permitting the tailoring of the individual coating layers to suit specific applications such as to produce gradients within the coating to concentrate the solid lubricant at or near the exposed surface. In step S112, the coating is applied to the component to be coated using a suitable thermal spray process that includes, but is not limited to, high velocity oxygen fuel (HVOF), high velocity liquid fuel (HVLF), high velocity air fuel (HVAF), plasma, cold spray, and detonation processes.

The application of the coating in step S112 is performed such that the resulting internal stresses are either neutral or compressive. This can be achieved by minimizing particle temperature and maximizing particle velocity through proper selection of process parameters specific to each thermal spray process. The control of stresses is further enhanced by spraying the coating at high surface speeds to minimize the amount of material that is applied per pass, as well as the efficient use of cooling procedures to maintain an even temperature during the coating process. Maintaining the component temperature consistently is important in maintaining the suitable amount of lubricating constituents within the protective coating as well as controlling the buildup of internal stress.

In step S114, the coating is finished with suitable equipment necessary to attain the optimal surface finish and dimensions. For example, diamond grinding is typically used to remove material and achieve these final dimensional and finish requirements. The importance of retaining a suitable amount of solid lubricant within the coating during spraying then comes into effect as the inherent nature of the diamond grinding process will “pull out” some, but not all, exposed solid lubricant particles. As discussed below with respect to FIG. 1, the pull out of some of the larger solid lubricant particles is important in establishing micro-pores on the surface of the coating.

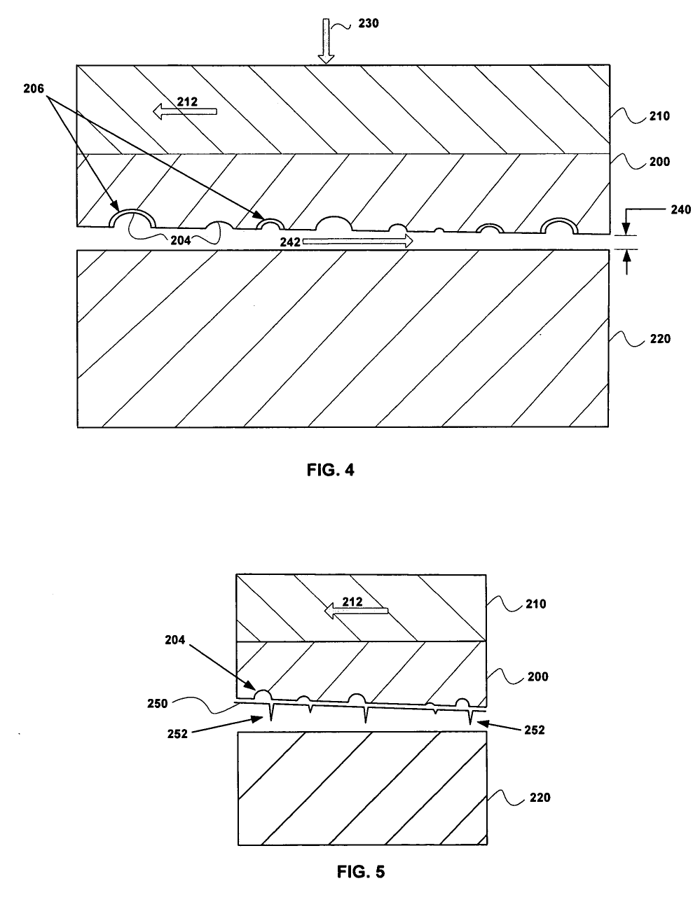

The dynamics of the finished coating of the present invention are illustrated in FIG. 4, which provides a cross-sectional view of a coating in accordance with the novel process described above. Referring to FIG. 4, a coating 200 is applied to a substrate 210, which is functionally engaged to a mating part 220 by a load 230. The substrate 210 with coating 200 is separated from the mating part 220 by a nominal operating gap 240 generated by either the pressurized lubricant or hydrodynamic pressure as a result of the substrate 210 being in motion relative to the mating part 220. Liquid lubricant flows through the gap 240 in a direction 242, relative to the direction of movement 212 of the substrate 210. During the finishing process, the pull out of some of the larger solid lubricant particles in the coating creates micro-pores 204 on the surface of the coating 200. The micro-pores 204 help create the desired hydrodynamic forces necessary to maximize the coatings' performance. A solid lubricant reservoir 206 is created by the micro-pores 204. The remaining solid lubricant in the coating, such as carbon (graphite), has good wetting characteristics with water and organic lubricants. These micro-pores 204 increase the boundary lubrication regime at the surface of the coating layer 200, thereby improving the hydrodynamic and elasto-hydrodynamic range between the two mating surfaces. These surface discontinuities brought about by these lubricating pockets (which are formed from micro-pores 204) aid to introduce additional hydrodynamic pressure peaks, thereby increasing the forces keeping the two opposing surfaces of mating part 220 and coating 200 apart.

FIG. 5 shows the hydrodynamic pressure peaks created by the micro-pores. Specifically, a representative pressure scale 250 shows hydrodynamic pressure peaks 252 that occur just after each micro-pore 204 as the substrate 210 and coating 200 travel in direction 212 relative to mating part 220.

The micro-pores also allow for expansion and contraction of the substrate and protective coating layer due to temperature fluctuations in operation. Each pore on the surface serves as a stress relief point; and the entrapped solid lubricant internal to the coating, being softer and less dense than the hard phase material serves also in the same fashion. Any tendencies for the coating to crack from stress are relieved when the crack encounters either a pore for a surface crack or a solid lubricant region in the interior of the coating. These micro-pores are also beneficial in certain components when being installed into machinery. Very often the clearances are tight, sometimes less than 1/1000 of an inch, and these components require shrink fitting onto other components. This involves using a heating mechanism, typically an oxygen-acetylene flame to expand and fit the component. Once the components are fitted they are often shrunk using an accelerant such as immersing them in cold water or using liquid carbon dioxide, nitrogen or argon. These coatings exhibit good thermal shock resistance properties in that any stress cracks that develop do not propagate and remain as short micro-cracks that do not propagate farther than the average distance between solid lubricant particles.

Suitable applications for a coating with low coefficient of friction according to the present invention are in turbo-machinery, pumps and engines with typical components being seals, bearings and piston rings. The coating is, for example, usable as a protective layer for wear rings, balance drum, impeller wear rings and various components in boiler feed pumps, where these components operate in conditions void of lubrication at startup and pump fresh and/or saline, medium to high pH water, and particulate matter of various size and volume. The small (smaller than 2 μm and preferably small than 0.5 μm) carbide phases of the coating act to reduce abrasive, corrosive and erosive wear whilst offering oxidation resistance. The inclusion of solid lubricants allows these carbides to perform at maximum capability by reducing the amount of rubbing, galling, fretting and pickup, particularly in conditions void of any lubrication. The presence of micro-pores aids in hydrodynamic lubrication, especially at lower speeds.

Experimental testing of the present invention was performed in two sets of tests. First, initial test work was completed to optimize a coating for a specific application by spraying a variety of different material and blend compositions. Test coupons for pin-on-disc, corrosion, erosion, and metallographic analysis were sprayed to determine the material compositions with the most potential for a particular application that being boiler feed pump components. Next, subsequent testing included spray testing of actual boiler feed pump wear rings and measuring the thermal shock and direct flame impingement characteristics.

Pin-on-disc tests generally are performed to determine the wear resistance and friction co-efficient of the coating with water added to the interface to simulate the actual lubricating medium. In tests of coatings of the present invention, a stainless-steel pin was pressed with a pre-determined load against the finished coating which rotated at staged speeds. The coating to be tested thus formed the contact surface with the pin and its resultant wear rate was measured. In the tests, the critical load for the onset of “scuff tracks” is determined. Erosion testing was performed to determine the coatings' ability to resist abrasion against water jet impingement containing abrasive particulate. Corrosion testing was performed by measuring the breakthrough potential of each coating at pH values of 6.5 and 9.0 respectively.

Superior corrosion and erosion results were obtained using a Sulzer Metco SM5241 CrC Ni C hard face material (approximately chrome carbide 54% weight, nickel 39% weight, and carbon 7% weight), with a small size distribution (less than 2 μm) proportion of carbide particles. This material displayed its best erosion resistance at low impact angles (e.g., 15 degrees) and higher erosion resistance relative to other materials such as tungsten carbide, hasetlloy C, and nano titanium oxide at high impact angles (e.g., 90 degrees), due in part to the small chrome carbide particles. This material also displayed high corrosion resistance at medium to high pH values. In comparison to the other materials this was a preferred, but not the only, choice for use as the hard face material in the present invention. It must be noted the carbon indicated in the CrC Ni C material is a residual, present in small amounts of less than 1%, residual in the process of forming the carbide.

Further initial experimental tests, including pin-on-disc tests (ASTM G99), were performed with the original CrC Ni C hard face material blended with a 25 weight percentage of Ni 25C_{Graphite} (25 weight percentage of graphite particles clad in a nickel sheath) to serve as the solid lubricant. The HVOF spray process, where the powder is applied onto the substrate at velocities exceeding 500 m/sec, produced coating results with compressive residual stress, a relatively smooth coating finish, and even distribution of solid lubricant particles in the hard phase material.

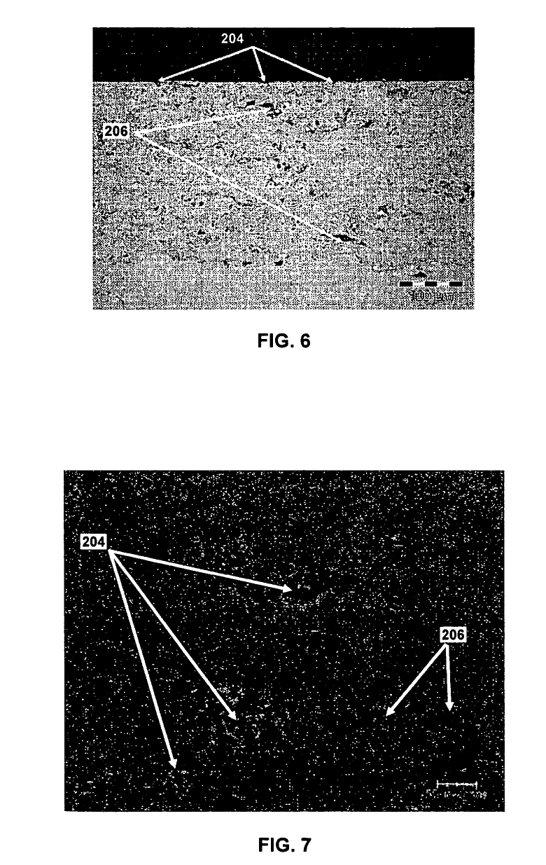

FIG. 6 is an SEM micrograph showing a cross section of the coating microstructure as sprayed. The inclusion of solid lubricants 206 are shown throughout the thickness of the coating, while micro-pores 204 exist on the surface after finishing. The coating shown in FIG. 6 produced a micro-hardness of 713HV_{200gpm} (approximately 13% lower than the hardness achieved with the chromium carbide hard face material alone).

Wear and friction measurements using the pin-on-disc test in water at 20 degrees C, showed the onset of adhesive wear at 175 N/mm² at 0.5 m/sec (approximately 175% higher than coatings of the CrC Ni C hard face material alone) and 25 N/mm² at 1 m/sec (approximately 25% higher than coatings of the CrC Ni C hard face material alone). Thus, the presence of the solid lubricant and pores increased the resistance to adhesive wear most at lower speeds when hydrodynamic forces are the lowest. ASTM G99 test results on 314 stainless steel and similar alloys indicate the onset of adhesive wear at less than 25 N/mm² under both test velocity conditions.

FIG. 7 is a SEM micrograph showing the coating surface of the coating in FIG. 6 after finishing and at 200× magnification. On the surface are micro-pores 204, which are essential to create a hydrodynamic layer between the coating and mating surface under operating conditions. Solid lubricant particles 206 are also present at the surface.

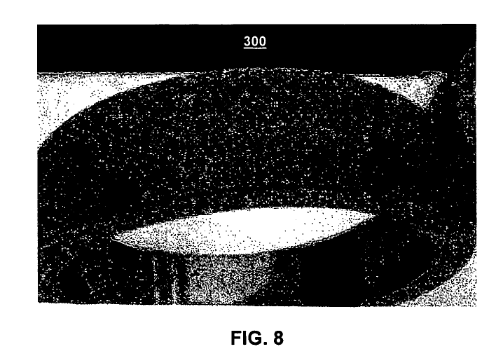

Thermal shock experimental testing was performed by spraying the coating onto a boiler feed pump wear ring 300, shown in FIG. 8, and increasing the component temperature to 465 degrees F. (240° C.) in a preheated oven and directly placing the component in 1.35 gallons (5 liters) of water at 71 degrees F. (21° C.). Once the component achieved room temperature it was inspected for cracks using a penetrating dye and no cracks were observed. Application of typical wear coatings alone using this method of heating and shrink fitting will almost always produce visible cracking in the coating. (In laboratory testing, for example, cracks were found in a wear ring component coated with a WC—CoCr coating applied with conventional application techniques that was subjected to the typical thermal shock experienced as part of the component assembly process.) FIG. 8 shows the pump wear ring 300, which was coated with a coating applied in accordance with the present invention, after thermal shock testing that shows no cracking evident at the surface including the edges where cracking is typically expected. Flame infringement testing produced similar results with no cracking.

While exemplary embodiments of the invention have been shown and described herein, it will be obvious to those skilled in the art that such embodiments are provided by way of example only. Numerous insubstantial variations, changes, and substitutions will now be apparent to those skilled in the art without departing from the scope of the invention disclosed herein by the Applicants. Accordingly, it is intended that the invention be limited only by the spirit and scope of the claims, as they will be allowed.

We claim:

1. A method of forming a coating with a low coefficient of friction that is wear resistant, corrosion resistant, and heat resistant, said method comprising the steps of:
providing hard face material particles;
providing solid lubricant material particles;
applying both of said particle types to a substrate to form said coating, wherein said coating comprises a blend of the hard face material and the solid lubricant material.

2. The method of claim 1, wherein the hard face material particles comprise one or more of chromium carbide, tungsten carbide, titanium carbide, molybdenum carbide, and vanadium carbide.

3. The method of claim 2, wherein the hard face material particles are produced using a spray dried and sintered process, said hard face particles having a particle size of about 2 μm or smaller.

4. The method of claim 2, wherein the hard face material particles are produced using a atomizing process, said hard face particles having a particle size of about 0.5 μm or smaller.

5. The method of claim 2, further comprising the step of agglomerating said hard face material particles into larger hard phase particles using a binder material, wherein said binder material comprises one or more of cobalt, nickel and iron alloyed with one or more of chrome, molybdenum, vanadium, and copper.

6. The method of claim 1, wherein the hard face material particles comprise one or more of nano titanium oxide, nano chrome oxide, and nano aluminum oxide.

7. The method of claim 6, wherein said hard face material particles have a particle size of about 0.1 μm or smaller prior to agglomeration into larger particles suitable for thermal spraying.

8. The method of claim 1, wherein the solid lubricant material particles comprise one or more of graphite, boron nitride, silicone, polyester, and PTFE clad or sheathed in nickel, cobalt, copper, molybdenum, gold and alloys thereof.

9. The method of claim 1, wherein the solid lubricant material particles comprise one or more of graphite, boron nitride, silicone, polyester, and PTFE spray dried with a binder material.

10. The method of claim 9, wherein said binder material is polyvinyl alchohol (PVA) or carboxymethylcellulose (CMC).

11. The method of claim 1, wherein said step of applying comprises use of a high velocity oxygen fuel, high velocity air fuel, or high velocity liquid fuel thermal spray process.

12. The method of claim 11, wherein said coating has neutral to compressive stress.

13. The method of claim 1, wherein said step of applying comprises use of a plasma spray process.

14. The method of claim 13, wherein said coating has neutral to compressive stress.

15. The method of claim 1, wherein said step of applying includes use of a cold spray process.

16. The method of claim 15, wherein said coating has neutral to compressive stress.

17. The method of claim 1, wherein said step of applying includes use of a detonation spray process.

18. The method of claim 17, wherein said coating has neutral to compressive stress.

19. The method of claim 1, further comprising the step of grinding said coating to desired surface finish and dimensions.

20. A coating with a low coefficient of friction that is wear resistant, corrosion resistant, and heat resistant, prepared by a process comprising the steps of:
providing hard face material particles of one or more of chromium carbide, tungsten carbide, titanium carbide, molybdenum carbide, vanadium carbide, nano titanium oxide, nano chrome oxide, and nano aluminum oxide;
agglomerating said hard face material particles into larger hard phase particles using a first binder material;
providing solid lubricant material particles of one or more of graphite, boron nitride, silicone, polyester, and PTFE;
agglomerating said solid lubricant material particles into larger particles using a second binder material; and
applying to a substrate said agglomerated hard face material particles and said agglomerated solid lubricant material particles via a thermal spray process.

21. The coating of claim 20, wherein the hard face material particles have a particle size of about 2 μm or smaller.

22. The coating of claim 21, wherein said step of applying comprises use of at least one of a high velocity oxygen fuel process, high velocity air fuel process, high velocity liquid fuel thermal spray process, plasma spray process, cold spray process and detonation spray process.

23. The coating of claim 21, wherein said coating has neutral to compressive stress.
